(19) United States
(12) Patent Application Publication
(10) Pub. No.: US 2015/0336218 A1
(43) Pub. Date: Nov. 26, 2015

(54) METHOD FOR REGENERATING AND/OR INCREASING THE DURABILITY OF A MILL ROLL

(71) Applicant: PLASMA SYSTEM S.A., Siemianowice Slaskie (PL)

(72) Inventors: Aleksander BOREK, Katowice (PL); Krzysztof DUDZINSKI, Bloeslaw (PL)

(73) Assignee: PLASMA SYSTEM S.A., Siemianowice Slaskie (PL)

(21) Appl. No.: 14/758,689

(22) PCT Filed: Dec. 19, 2013
(86) PCT No.: PCT/PL2013/000171

§ 371 Date: Jun. 30, 2015

(30) Foreign Application Priority Data
Dec. 31, 2012 (PL) P.402318

(51) Int. Cl. B23K 35/30; B23K 26/34; B21B 27/02

(52) U.S. Cl. CPC B23K 35/3086; B23K 35/306; B21B 27/024; B23K 26/34

(57) ABSTRACT

A method for regenerating and increasing durability of a mill roll, which is characterized in that lateral working surfaces (2) of a mill roll (1), having the width of 20 mm to 400 mm, are covered preferably by means of the laser cladding with a layer of metallic material (3) having the thickness of 0.1 to 4.0 mm, preferably 1.5 to 2.0 mm.

The present invention refers to the method for regenerating and increasing durability of a mill roll used for plastic metalworking, e.g. metal rolling, of metals such as steel, copper and its alloys, aluminum and its alloys.

Mill rolls for rolling mills that are currently in use usually have surfaces made of a compact metal, and the surfaces undergo the non-uniform wear while the mill rolls come into contact with a rolled metal, which results in that the mill roll calibration is lost (i.e. in discalibration), and that in turn leads to the undesired changes in the rolled products dimensions.

Polish patent specification PL116285 discloses cast iron that is used for production of homogenous mill rolls; Polish patent specification PL115266 discloses cast iron that is used for production of uniform mill rolls; and Polish patent specification PL115270 discloses hypereutectoid cast iron for mill rolls. The above Polish patents disclose chemical compositions of the materials that have been used for producing mill rolls so far.

The cast iron for producing mill rolls disclosed in PL116285 comprises 3.1-3.5% of C, 0.6-1.1% of Mn, 1.4-2.1% of Si, 0.5-0.8% of Cr, 0.6-1.1% of Mo, 3.0-4.2% of Ni, 0.002-0.005% of Y, 0.002-0.006% of Sr, 0.003-0.006% of Ce, 0.002-0.006% by Br, up to 0.08% of Mg, up to 0.024% of S, up to 0.13% of P, with the balance being Fe and unavoidable impurities (the composition is expressed in percentage by weight).

The cast iron for producing uniform mill rolls disclosed in PL115266 comprises 3.2-3.45% of C, 0.40-0.70% of Mn, 1.00-1.40% of Si, 1.00-1.40% of Cr, 0.20-0.60% of Mo, 1.00-1.40% of Ni, 0.001-0.005% of Y, 0.0003-0.0005% of Te, up to 0.045% of S, up to 0.12% of P, with the balance being Fe and unavoidable impurities (the composition is expressed in percentage by weight).

The hypereutectoid cast steel for producing mill rolls disclosed in PL115270 comprises 1.9-2.3% of C, 0.4-0.8% of Mn, 0.4-1.0% of Si, 0.6-1.2% of Cr, 0.2-0.4% of Mo, 0.3-0.6% of Ni, 0.0001-0.0002% of Br, up to 0.04% of S, up to 0.06% of P, with the balance being Fe and unavoidable impurities (the composition is expressed in percentage by weight).

In the prior art there are known methods for regeneration of rolling mill rolls employed in metalworking processes. For example some known methods for regeneration of mill rolls consist of covering the mill roll surfaces that are worn out with a layer of metallic material by means of the arc welding technique. However, such methods do not provide acceptable results for mill rolls made of cast steel with low amount of C, since the obtained coatings have a tendency to loosen.

Therefore, the known regeneration methods cannot be effectively used for the simultaneous size and shape recovering after the mill roll made of steel with low amount of C is abrasively worn out. Especially, the arc welding technique cannot be used for mill rolls made of steel with low amount of C as the obtained arc weld is of a poor quality as it is prone to cracking as a result of arc welding.

The method for regenerating and increasing durability of a mill roll of the present invention is characterized in that lateral working surfaces (2) of the mill roll (1), having the width of 20 to 400 mm, are covered by means of the laser cladding with a layer of metallic material (3) with the thickness of 0.1 to 4.0 mm, preferably 1.5 to 2.0 mm, and preferably the layer of the metallic material (3) may comprise carbon from 0.05% to 3.90%, manganese from 0.10 to 2.90%, chromium from 0.50 to 30.00%, nickel from 0.50% to 51.00%, titanium from 0.05% to 5.50%, silicon from 0.10% to 2.40%, molybdenum from 0.04% to 4.50%, tungsten from 0.90% to 4.50%, cobalt from 1.50% to 10.00%, vanadium from 0.20% to 4.00%, phosphorus up to 0.15%, sulfur up to 0.04%, copper from 0.10% to 1.20%, magnesium from 0.03% to 0.07%, yttrium from 0.001% to 0.005%, boron from 0.002% to 0.006%, tellurium from 0.0005% to 0.002%, strontium from 0.002% to 0.006%, cerium from 0.003% to 0.006%, and iron being the rest as expressed in percentage by weight.

Preferably prior the laser cladding step a layer of native material is removed to the depth of 0.1 to 4.0 mm, preferably up to 2.0 mm, from the worn out lateral working surface (2) of the mill roll (1), and then the layer of metallic material (3) with the thickness of 0.1 to 4.0 mm, preferably up to 2.0 mm, is applied on the exposed lateral working surface (2) by means of laser cladding, and next the layer of metallic material (3) is preferably adjusted to the basic size.

Optionally the dimensions of the lateral working surface (2) of the mill roll (1) are understated at production to the depth of 0.1 to 4.0 mm, preferably up to 2.0 mm, in relation to the basic size, and then the layer of metallic material (3) with the thickness of 0.1 to 4.0 mm, preferably up to 2.0 mm, is applied on the understated lateral working surface (2) by means of laser cladding, and next the layer of metallic material (3) is preferably adjusted to the basic size.

In addition, and still more preferably, the extreme working surfaces (4) of the mill roll (1) are subjected to the laser surface hardening preferably to the depth of 0.1 to 3.0 mm, more preferably 1.5 to 2.0 mm.

Another method for regenerating and increasing durability of a mill roll of the present invention is characterized in that lateral working surfaces (2) and extreme working surfaces (4) of the mill roll (1) are laser surface alloyed to the depth of 0.05 to 2.00 mm, with application of the following parameters: laser beam output power from 1000 W to 5000 W, laser beam focal length of 82 mm/32 mm, laser beam dimensions 1.8 mm×6.8 mm, range of power density in the plane of laser beam focus of 2 kW/cm² to 50 kW/cm², spot moving rate about 0.5 m/s, and with application of one or more materials selected from tungsten carbide, titanium carbide, tantalum carbide, silicon carbide, vanadium carbide, zirconium carbide, titanium boride, tungsten boride, cobalt, tungsten, nickel, chromium, manganese, vanadium, molybdenum, titanium, silicon, titanium nitride, aluminum oxide, hafnium oxide, zirconium oxide, titanium oxide, chromium oxide and diamond.

The mill roll (1) subjected to the above treatments is preferably designed for producing H-sections.

Furthermore, the mill roll is preferably made of cast steel comprising preferably 0.6 to 0.9% by weight of C.

The mill roll is preferably made of steel comprising 0.6-0.7% of C, 1.0-1.1% of Mn, 0.35-0.45% of Si, 2.7-3.0% of Cr, 0.5-0.6% of Mo, 0.1-0.15% of V, 0.3-0.4% of Ni, up to 0.01% of S, up to 0.15% of P, and the rest is Fe and unavoidable impurities.

Alternatively the mill roll is made of steel comprising 0.8-0.9% of C, 0.3-0.6% of Mn, 0.15-0.35% of Si, 0.4-0.7% of Cr, 0.2-0.3% of Cu, 0.15-0.3% of V, 0.3-0.35% of Ni, up to 0.03% of S, up to 0.03% of P, and the rest is Fe and unavoidable impurities.

One of the preferred metallic materials used for the laser cladding comprises 0.70% of C, 0.90% of Mn, 1.50% of Si, 1.20% of Cr, 2.00% of Ni, up to 0.10% of P, and the rest is Fe and unavoidable impurities.

Another preferred metallic material comprises 0.01-0.03% of C, 1.0-2.0% of Mn, 0.1-1.1% of Si, 17.0-19.0% of Cr, 2.0-3.5% of Mo, 12.0-16.0% of Ni, and the rest is Fe and unavoidable impurities.

Another preferred metallic material comprises 0.9-1.4% of C, 27.0-32.0% of Cr, 4.0-6.0% of W, and the rest is Co and unavoidable impurities.

Still another preferred metallic material comprises more than 66% of Co, more preferably 66.0-70.0% of Co.

Another preferred metallic material comprises 0.9-1.4% of C, 27.0-32.0% of Cr, 4.0-6.0% of W, and the rest is Co and Nb blend with 7.0-15.0% of Nb included in the Co and Nb blend and unavoidable impurities.

Another preferred metallic material comprises 0.9-1.4% of C, 27.0-32.0% of Cr, 4.0-6.0% of W, 5.0-8.0% of Nb, and the rest is Co and unavoidable impurities.

All the compositions are expressed in percentage by weight.

The metallic powder used for the laser cladding has preferably the particle size of 45 to 150 μm.

The advantage of the method for regeneration and increasing durability of a mill roll according to the present invention consists in that the lateral surfaces (almost perpendicular to the axis of the roll) that are most subjected to the wear are covered and/or filled-in with an additive material of increased wear resistance or the surfaces are hardened by means of laser treatment to the hardness that is sufficient for protection of the mill roll from the undesired discalibration.

The method of the present invention employs the following technologies:

The laser beam welding technology usually employs a continuous-wave, convectively cooled CO₂ laser with either gaussian output beam or hollows output beam optics. More preferable lasers include a fiber laser, a disc laser, and a diode laser. These lasers, available in output powers ranging from approximately 1000 to 15000 W, have been used to demonstrate specific welding accomplishments in a variety of metals and alloys. Substantial advances in laser technology made possible the production of fully automated multikilowatt industrial laser systems which can be operated on a continuous production basis. These systems can be used for a variety of development programs and on-line production applications, e.g. for producing a cladding layer.

The laser cladding as employed in the method of the present invention is used to build up metal surfaces after it has been worn down. It can be preformed on flat or round surfaces. In general the laser cladding consists of depositing several layers of beads. The welding beads can cover completely or in part the previous beads to form welding seams (a padded weld) that while conducted repeatedly in a regular manner may produce a net-like coating.

The laser surface alloying is a surface modification technology, wherein the alloying elements, e.g. ceramic materials deposited on the substrate surface, are irradiated by a high energy laser beam to melt rapidly and while subsequent cooling to form an alloy together with the substrate surface material.

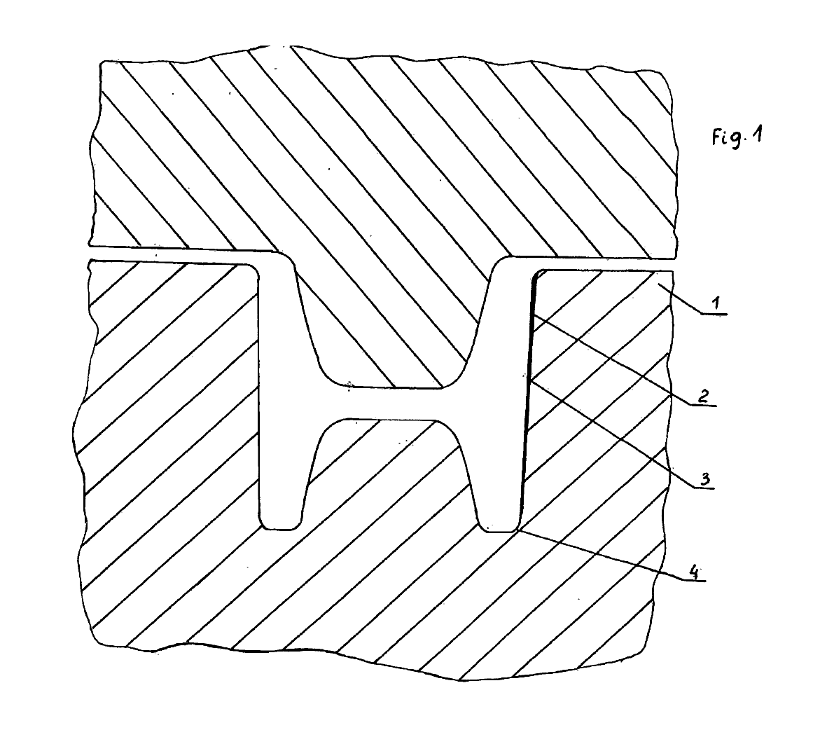

The embodiment of the present invention is presented in the drawing on FIG. 1 which shows the cross-section of a regenerated mill roll.

The mill roll (1) presented in FIG. 1 is designed for producing H-sections by the hot rolling process. The mill roll (1) is usually subjected to the most intensive wearing out on its lateral working surfaces (2). The worn out mill roll (1) was subjected to the regeneration method of the present invention. First, a layer of native material was removed to the depth of about 1.50 mm from the worn out lateral working surfaces (2) of the mill roll (1). The obtained surfaces were evened up. The evened surfaces were subjected to the laser cladding process with a layer of a metallic material (3) with the thickness of about 2.00 mm. The metallic material (3) used for the laser cladding had the following chemical composition: 0.70% of C, 0.90% of Mn, 1.50% of Si, 1.20% of Cr, 2.00% of Ni, up to 0.10% of P, and the rest is Fe and unavoidable impurities (the composition is expressed in percentage by weight).

Next, the mill roll (1) was subjected to the mechanical working (i.e. the standard machining after welding) to the predetermined dimensions as desired by gathering the excess of the padding weld with the thickness of about 0.50 mm to form the machined surface of the layer of the metallic material (3).

Extreme surfaces (4) of the mill roll (1) are also subjected to intensive wearing out, and therefore the extreme surfaces (4) were subjected to the laser surface hardening without any additive material to the depth of 1.50 mm by means of a laser treatment with the power output of about 2000 W, to the hardness of about 53-55 HRC.

### EXAMPLE 1

Mill roll with the weight of 18.5 Mg, the length of 5465 mm, and the maximum diameter Ømax of 1240 mm

The regeneration of the workpiece consisted in the size and shape recovering of the damaged part of the rolling mill roll made of forged steel 70H3GNMF (from NKMZ, Russia) with the following chemical composition expressed in percentage by weight:

| C | Mn | Si | Cr | Mo | V | Ni | S | P |
|---|---|---|---|---|---|---|---|---|
| 0.6- | 1.0- | 0.35- | 2.7- | 0.5- | 0.1- | 0.3- | 0.01 | 0.015 |
| 0.7 | 1.1 | 0.45 | 3.0 | 0.6 | 0.15 | 0.4 | | |

with the balance being Fe and unavoidable impurities.

The surface to be subjected to the regeneration treatment was in the form of a breach having the approximate dimensions of 250×60×65 mm (L×W×H). The shape reconstruction was carried out with employing the laser cladding technology. The process was conducted according to the following steps:

1.1. Preparing the photographic documentation, conducting the accurate visual inspection and the dye penetrant inspection of the damaged surface in order to detect any inconsistencies;
1.2. Designing the workshop documentation in the form of an operation sheet containing the exact description and parameters of the process for reconstruction of the damaged part of the workpiece;
1.3. Purification and developing of the surface (by grinding) with using the abrasive machining operation at the damaged part of the mill roll, to provide the adequate support for the additive material employed for the reconstruction;
1.4. Proper washing of the workpiece with isopropyl alcohol from oils and greases;
1.5. Preparing the workpiece to the preliminary heating step—the heating mats were mounted in the vicinity of the damaged surface on the largest diameters of the mill roll, the monitoring and controlling thermocouples were welded and the thermal insulation installed. The heating to the temperature of 200° C. was performed using an electrical resistance heat treatment unit. The heating rate was 20° C./h;
1.6. Beginning of the reconstruction process with using the laser cladding technology after reaching the required temperature throughout the entire volume of the workpiece. The laser cladding was conducted with the use of the following components:
a) High power diode laser with the output power of 4000 W
b) Laser head with a coaxial powder nozzle for the powder feeding with the efficiency in terms of the deposition area of about 0.5 m²/h
c) Six-axis articulated arm robot with the lifting capacity of about 60 kg and the range of about 2.5 m
d) Gravimetric powder feeder

The pad welding seams were conducted alternately, perpendicularly to each other, in order to obtain the best mechanical properties of the cladding layer.

1.7. The size and shape reconstruction of the mill roll was performed with using the metallic powder with the following chemical composition expressed in percentage by weight:

| C | Mn | Si | Cr | Mo | Ni |
|---|---|---|---|---|---|
| 0.01-0.03 | 1.0-2.0 | 0.1-1.1 | 17.0-19.0 | 2.0-3.5 | 12.0-16.0 |

with the balance being Fe and unavoidable impurities, and with the particle size from 45 to 150 μm.
1.8. Process parameters:
a) Laser output power: 3000 W
b) Optical fibre diameter Ø: 600 μm
c) Pad pitch: 2 mm
d) Processing speed: 20 mm/s
e) Working distance of the laser head: 15 mm
f) Powder feed rate: 20 g/min
g) Shielding gas: 15 l/min
h) Powder carrying gas: 15 l/min
1.9. After completion of the laser cladding process the workpiece was cooled down under control at the rate of 8° C./h;
1.10. The use of the modern laser cladding technology is the best method for carrying out the regeneration of this type of workpiece, due to the best quality of the padded weld and the minimum amount of the heat input. The padded weld after the dye penetrant inspection occurred to be free of any discontinuities in the form of pores and cracks.

### EXAMPLE 2

Mill rolls (3 items) with the weight of 3 to 6 Mg, the length of 3500 to 4000 mm, and the maximum diameter Ømax of 800 to 900 mm

The regeneration of the workpieces consisted in the size recovering and improving the functional properties of the lateral working surfaces (2) of the mill rolls (1) designed for producing H-sections (FIG. 1) and made of forged steel 90HF with the following chemical composition expressed in percentage by weight:

| C | Mn | Si | Cr | Cu | V | Ni | S | P |
|---|---|---|---|---|---|---|---|---|
| 0.8- | 0.3- | 0.15- | 0.4- | 0.2- | 0.15- | 0.3- | 0.03 | 0.03 |
| 0.9 | 0.6 | 0.35 | 0.7 | 0.3 | 0.3 | 0.35 | | |

with the balance being Fe and unavoidable impurities.

The surface to be subjected to the regeneration treatment and to the treatment for increasing the abrasion resistance at elevated temperatures was a portion of the working pass of the mill roll with the approximate area of 0.5-0.8 m². The regeneration was performed using the laser cladding technology. The process was conducted according to the following steps:

2.1. Preparing the photographic documentation, conducting the accurate visual inspection and the dye penetrant inspection of the surface to be pad welded in order to detect any inconsistencies;
2.2. Designing the workshop documentation in the form of an operation sheet containing the exact description and parameters of the process for the regeneration and increasing the abrasion resistance of the mill rolls;
2.3. The surface level lowering (i.e. forming the depression) by using the machining at the abrasively worn out places of the mill rolls;
2.4. Proper washing of the workpieces with isopropyl alcohol from oils and greases;
2.5. Preparing the workpieces to the preliminary heating step—the mill rolls were preliminary heated up to the temperature of 200° C. (with the temperature rising slop of 12° C./h) in the specially prepared an electrical resistance heating bath. The temperature was measured with a single contact thermocouple fastened on a stand.
2.6. Beginning of the regeneration process with using the laser cladding technology after reaching the required temperature throughout the entire volume of the workpiece. The laser cladding was conducted with the use of the following components:
a) High power fiber laser with the output power of 6000 W
b) Laser head COAX 13 (Fraunhofer) for coating of difficult-to-access functional areas with a coaxial powder nozzle for the powder feeding with the efficiency in terms of the deposition area of about 0.3 m²/h
c) Six-axis articulated arm robot with the lifting capacity of about 60 kg and the range of about 2.5 m
d) High-accuracy feeding (±2%) gravimetric powder feeder equipped with the balance
2.7. The dimension reconstruction and increasing the wear resistance of the mill rolls was performed with using the metallic powder with the following chemical composition expressed in percentage by weight:

| C | Cr | W |
|---|---|---|
| 0.9-1.4 | 27.0-32.0 | 4.0-6.0 |

with the balance being Co (with up to 68.1% of Co) and unavoidable impurities, and with the particle size from 45 to 150 μm.
2.8. Process parameters:
a) Laser output power: 1850 W
b) Optical fibre diameter Ø: 300 μm
c) Pad pitch: 1.2 mm
d) Processing speed: 16 mm/s
e) Working distance of the laser head: 15 mm
f) Powder feed rate: 20 g/min
g) Shielding gas: 12 l/min
h) Powder carrying gas: 6 l/min
2.9. After completion of the laser cladding process the workpiece was cooled down under control at the rate of 10° C./h;
2.10. The use of the modern laser cladding technology is the best method for carrying out the regeneration of this type of workpiece, due to the best quality of the padded weld and the minimum amount of heat input. The padded weld after the dye penetrant inspection occurred to be free of any discontinuities in the form of pores and cracks.

The method of the present invention due to the application of the most modern technology of laser cladding allows restoring the functionality of worn out mill rolls. After being subjected to the regenerating process of the present invention the mill roll also gains high resistance to abrasive wear and corrosion.

1-5. (canceled)

6. A method for regenerating and increasing durability of a mill roll designed for producing H-sections wherein lateral working surfaces of the mill roll for producing H-sections, having the width of 20 to 400 mm, are covered by means of the laser cladding with a layer of metallic material (3) with the thickness of 0.1 to 4.0 mm, preferably 1.5 to 2.0 mm.

7. The method according to claim 6, wherein the metallic material comprises 0.01-0.03% of C, 1.0-2.0% of Mn, 0.1-1.1% of Si, 17.0-19.0% of Cr, 2.0-3.5% of Mo, 12.0-16.0% of Ni, and the rest is Fe and unavoidable impurities.

8. The method according to claim 6, wherein the metallic material comprises 0.9-1.4% of C, 27.0-32.0% of Cr, 4.0-6.0% of W, and the rest is Co and Nb blend with 7.0-15.0% of Nb included in the Co and Nb blend and unavoidable impurities.

9. The method according to claim 6, wherein prior the laser cladding step a layer of native material is removed to the depth of 0.1 to 4.0 mm, preferably up to 2.0 mm, from the worn out lateral working surface of the mill roll, and then the layer of metallic material with the thickness of 0.1 to 4.0 mm, preferably up to 2.0 mm, is applied on the exposed lateral working surface by means of laser cladding, and next the layer of metallic material is preferably adjusted to the basic size.

10. The method according to claim 6, wherein the dimensions of the lateral working surface of the mill roll are understated at production to the depth of 0.1 to 4.0 mm, preferably up to 2.0 mm, in relation to the basic size, and then the layer of metallic material with the thickness of 0.1 to 4.0 mm, preferably up to 2.0 mm, is applied on the understated lateral working surface by means of laser cladding, and next the layer of metallic material is preferably adjusted to the basic size.

11. The method according to claim 10, wherein the extreme working surfaces of the mill roll are subjected to the laser surface hardening preferably to the depth of 0.1 to 3.0 mm, more preferably 1.5 to 2.0 mm.

12. The method according to claim 11, wherein lateral working surfaces and extreme working surfaces of the mill roll for producing H-sections are laser surface alloyed to the depth of 0.05 to 2.00 mm, with application of the following parameters: laser beam output power from 1000 W to 5000 W, laser beam focal length of 82 mm/32 mm, laser beam dimensions 1.8 mm×6.8 mm, range of power density in the plane of laser beam focus of 2 kW/cm² to 50 kW/cm², spot moving rate 0.5 m/s, and with application of one or more materials selected from tungsten carbide, titanium carbide, tantalum carbide, silicon carbide, vanadium carbide, zirconium carbide, titanium boride, tungsten boride, cobalt, tungsten, nickel, chromium, manganese, vanadium, molybdenum, titanium, silicon, titanium nitride, aluminum oxide, hafnium oxide, zirconium oxide, titanium oxide, chromium oxide and diamond.
